(19) United States
(12) Patent Application Publication
(10) Pub. No.: US 2005/0198972 A1
(43) Pub. Date: Sep. 15, 2005

(54) Pressure-temperature control for a cryoablation catheter system

(76) Inventors: David J. Lentz, La Jolla, CA (US); Matt M. Riordan, Saratoga, CA (US)

Correspondence Address: NYDEGGER & ASSOCIATES, 348 OLIVE STREET, SAN DIEGO, CA, 92103, US

(21) Appl. No.: 10/797,398

(22) Filed: Mar. 10, 2004

(51) Int. Cl. F17C 9/02; F25B 19/02; F25B 1/00

(52) U.S. Cl. 62/50.2; 62/467

(57) ABSTRACT

A heat transfer system and method for cryoablation includes a cryo-catheter with a tip, and a temperature sensor mounted at the distal end of the cryo-catheter. A system controller is in electronic communication with both a pressure regulator and the temperature sensor. The system takes advantage of the transfer of latent heat to minimize the tip temperature at the distal end of the cryo-catheter. More specifically, after measuring the temperature at the distal end of the cryo-catheter, and comparing the temperature data and input pressure to a known pressure-temperature curve, the input pressure of the liquid fluid refrigerant may be adjusted. At the correct pressure setting, the liquid fluid refrigerant will begin to boil at the distal end of the cryo-catheter, and the tip temperature will be at a minimum.

### FIELD OF THE INVENTION

The present invention pertains generally to interventional medical devices. More particularly, the present invention pertains to cryo-catheters that are used to ablate tissue in the vasculature of a patient. The present invention is particularly, but not exclusively useful as a device and method for measuring the tip temperature at the distal end of a cryo-catheter and using the temperature data to control, as necessary, the input pressure of the fluid refrigerant.

### BACKGROUND OF THE INVENTION

Catheter ablation procedures have been clinically available for many years. The typical procedure involves passing radiofrequency (RF) electrical energy through a catheter, thereby heating and subsequently cauterizing or burning the tissue. Recently it has become apparent that RF energy is not ideal for producing the larger lesions needed to treat complex arrhythmias such as atrial fibrillation. With larger lesions, the standard approach of using RF energy may cause serious safety concerns such as pulmonary vein stenosis, clots and even stroke. Cryoablation, on the other hand, helps to eliminate many of the problems associated with RF and other heat-related therapies. Advantages of cryoablation may include: reduced pain for the patient during the procedure; reduced risk of catheter movement during the procedure; reduced procedure time; and non-destructive mapping at the source of the arrhythmia.

With a cryoablation procedure, very low temperatures need to be generated at the distal end of the cryo-catheter. Furthermore, these temperatures must be confined to the area where tissue is to be cryo-ablated. Because cryoablation typically requires temperatures below about minus eighty-four degrees Centigrade (−84° C.), high thermally conductive materials (e.g. copper) are typically used in the manufacture of a cryo-catheter. More specifically, such materials are used for the tip at the distal end of a cryo-catheter. Consequently, the thermal conductivity for a cryoablation procedure is effectively controlled by the relatively lower conductivity of the tissue to be ablated. Thus, it can be appreciated that the local temperature gradient between the tissue and the cryo-catheter is a control variable of significant importance. It is desirable, therefore, to have cryo-catheter temperatures at the operational site that are as low as possible.

A principle of thermodynamics provides that a substantial amount of heat transfer in a substance can result without any measurable change of temperature. Specifically, this phenomenon involves the transfer of so-called “latent heat”, and occurs wherever a substance, such as a fluid refrigerant, changes state. By definition, “latent heat” is the heat which is required to change the state of a unit mass of a substance from a solid to a liquid, or from a liquid to a gas, without a measurable change of temperature. Insofar as cryo-catheters are concerned, due to their requirement for low operational temperatures, it is desirable to obtain the additional refrigeration potential that results during the transfer of latent heat. In the case of a fluid refrigerant, such as nitrous oxide (N₂O), it can be said that prior to a change in state from a liquid to a gas, the liquid refrigerant is “refrigerant in excess”. More specifically, for a defined system, while the fluid refrigerant is still in its liquid state, the latent heat required for vaporization is available to provide for an excess of refrigeration potential. On the other hand, after the fluid refrigerant begins to boil (i.e. change state from liquid to gas) the gas refrigerant is “refrigerant limited”.

For a cryoablation catheter having a coaxial supply tube and capillary tube, extending distally from the supply tube, wherein both tubes have known lengths and known lumen diameters, it is possible to plot a curve of tip temperature (“Tₜ”) as a function of working pressure (“p_{w}”). In this case, the working pressure “p_{w}” is the pressure of the fluid refrigerant as it is introduced into the supply tube for transfer into the capillary tube, and the tip temperature “Tₜ” is the temperature at the distal end of the capillary tube. Given an adequate working pressure “p_{w}” from the fluid refrigerant source, a sufficient decrease in pressure over the well-defined length of the capillary tube, and a vacuum assisted decrease in pressure at the distal end of the capillary tube, the pre-cooled refrigerant can be controlled to boil and transition from a liquid to a gas as it exits the distal end of the capillary tube. At this transition point, for a defined system, as the refrigerant changes from “refrigerant in excess” (i.e. liquid) to “refrigerant limited” (i.e. gas), the temperature at the tip (“Tₜ”) will be at a minimum.

To verify that the tip temperature “Tₜ” is at a minimum, a temperature sensor can be mounted on the distal end of the cryoablation catheter. The measured temperature can be compared to a pressure-temperature curve for the given catheter tube, and the tip temperature “Tₜ” can be minimized by controlling the input working pressure “p_{w}”.

In light of the above, it is an object of the present invention to provide a heat transfer system that can be safely introduced into the vasculature of a patient where it will create temperatures as low as about minus eighty-four degrees Centigrade. Another object of the present invention is to provide a heat transfer system that will minimize the measured tip temperature “Tₜ” by controlling the working pressure “p_{w}”. Still another object of the present invention is to provide a heat transfer system that is relatively easy to manufacture, is simple to use and is comparatively cost effective.

### SUMMARY OF THE INVENTION

A cryo-catheter (i.e. heat transfer system) in accordance with the present invention includes a supply tube having a proximal end and a distal end. The proximal end of the supply tube is connected in fluid communication with a source of fluid refrigerant, such as nitrous oxide (N₂O). Structurally, the distal end of the supply tube is connected in fluid communication with the proximal end of a capillary tube. Of note, the supply tube and the capillary tube are each formed with respective lumens of a known length and diameter. A tip member is connected to the distal end of the cryo-catheter, to surround the distal end of the capillary tube, thereby creating a cryo-chamber. A temperature sensor, in electronic communication with a system controller, is mounted at the distal end of the cryo-catheter.

In operation, the fluid refrigerant is introduced into the supply tube in a liquid state at a working pressure “p_{w}”. Typically the working pressure “p_{w}” will be controlled to be in a range between three hundred and fifty psia and five hundred psia (350-500 psia). The liquid refrigerant then sequentially transits through the supply tube and the capillary tube. As specifically intended for the present invention, the fluid refrigerant experiences much more resistance, and a much greater pressure drop, as it passes through the capillary tube than while passing through the supply tube.

Importantly, as the fluid refrigerant exits the distal end of the capillary tube, it is substantially still in a liquid state. The dimensions of both the supply tube and capillary tube are specifically chosen, and the working pressure “p_{w}” is actively controlled, to facilitate this result. The tip pressure “pₜ” on the fluid refrigerant, as it enters the cryo-chamber, is preferably less than about one atmosphere. As a result of the decrease in pressure to less than one atmosphere, the liquid refrigerant will begin to boil in the cryo-chamber, transitioning from a liquid state to a gaseous state. After the fluid refrigerant has transitioned into its gaseous state, the measured temperature, and hence the tip temperature “Tₜ”, will be at a minimum, and preferably less than about minus eighty-four degrees Centigrade (pₜ<−84° C.).

For a capillary tube having a known length and diameter, a curve can be plotted showing the tip temperature “Tₜ” (y-axis) as a function of working pressure “p_{w}” (x-axis). There is a region of the pressure-temperature curve where the fluid refrigerant transitions from a liquid state to a gaseous state. This transition region is characterized by a pronounced change in the slope of the curve. As can be understood by those skilled in the art, the slope may be defined as the change in temperature (ΔT) divided by the change in pressure (Δp). A positive slope, for example, would represent an increase in temperature with a corresponding increase in pressure (or, in the alternative, a decrease in temperature with a decrease in pressure). The slope of the curve changes from a value of near zero at higher pressures, when the fluid refrigerant is a liquid, i.e. “refrigerant in excess”, to a significantly negative slope at lower pressures, when the refrigerant is in a gaseous state, i.e. “refrigerant limited”. In this transition region, there may also be a change in the sign of the slope of the curve (e.g. from a (+) slope to a (−) slope as the pressure decreases).

For the purposes of the present invention, a temperature sensor is mounted on the distal end of the cryo-catheter. The temperature sensor measures and transmits the tip temperature “Tₜ” to the system controller. In the preferred embodiment of the present invention, the system controller includes a signal receiver, a processor, a pressure control algorithm, and a means for controlling the working pressure, “p_{w}”. After receiving the data, the system controller compares the tip temperature “Tₜ”, and working pressure “p_{w}”, to the pressure-temperature curve for the given capillary tube. Using the measured data, the system controller adjusts the working pressure “p_{w}” until such time as any increase in working pressure “p_{w}” results in little or no change in tip temperature “Tₜ”, and any decrease in working pressure “p_{w}” results in a significant change in tip temperature “Tₜ”. This point, in the transition region of the pressure-temperature curve, is indicative of the change in the fluid refrigerant from a liquid to a gas, as can be expected to occur at the distal end of the cryo-catheter tube (i.e. boiling in the cryo-chamber). This point also represents the point at which the tip temperature “Tₜ” is substantially at a minimum.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of a cryoablation system incorporating the present invention;

FIG. 2A is a cross-sectional view of the distal end of a cryo-catheter tube, with a temperature sensor mounted on the interior surface of the tip, as would be seen along the line 2-2 in FIG. 1;

FIG. 2B is a cross-sectional view of the distal end of a cryo-catheter tube with a temperature sensor mounted on the distal end of the capillary tube, as would be seen along the line 2-2 in FIG. 1; and

FIG. 3 is an exemplary graphical representation of a pressure-temperature curve, for a capillary tube of known length and diameter, plotting the tip temperature “Tₜ” as a function of the working pressure “p_{w}” of the fluid refrigerant.

### DESCRIPTION OF THE PREFERRED EMBODIMENTS

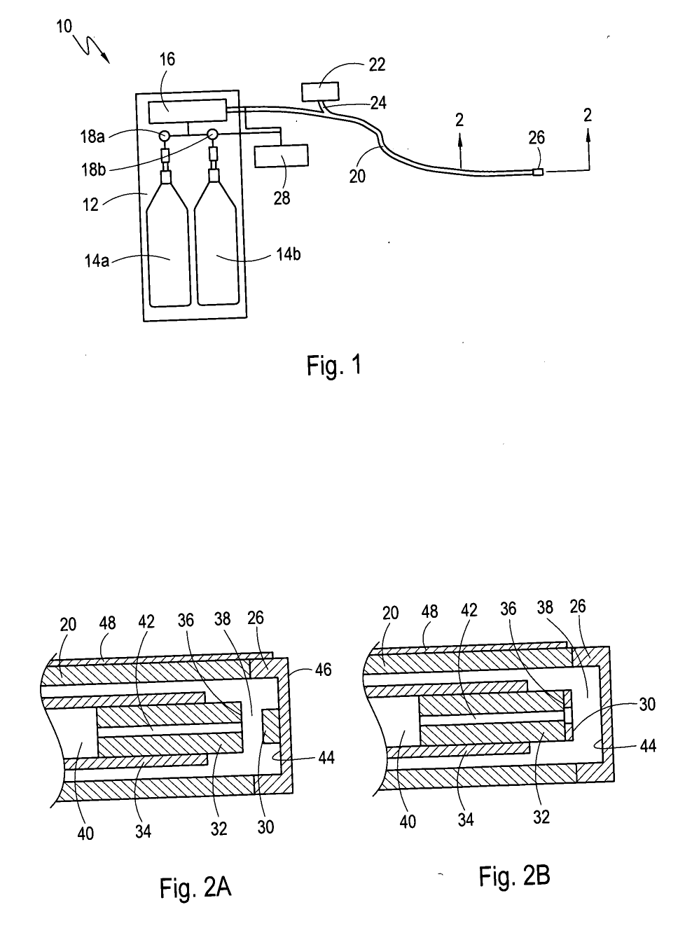

A system in accordance with the present invention is shown in FIG. 1 and is generally designated 10. In detail, the system 10 includes a console 12, inside of which are mounted two fluid refrigerant sources 14a and 14b. The fluid refrigerant sources 14a and 14b shown in FIG. 1 are, however, only exemplary. As contemplated for the present invention, the fluid refrigerant sources 14a and 14b may be any type pressure vessel known in the pertinent art that is suitable for holding and subsequently dispensing a fluid under relatively high pressures (e.g. 700 psi). Positioned between the fluid refrigerant sources 14a and 14b and a pre-cooler 16, are pressure regulators 18a and 18b. In operation, fluid refrigerant flows out of the fluid refrigerant sources 14a and 14b, through the pressure regulators 18a and 18b, and into the pre-cooler 16, where it is cooled. For the purposes of the present invention, the preferred fluid refrigerant is nitrous oxide (N₂O).

Still referring to FIG. 1, the pre-cooler 16 is in fluid communication with a cryo-catheter 20. A vacuum source 22, with a vacuum return line 24, is in fluid communication with the cryo-catheter 20 as well. Connected to the distal end of the cryo-catheter 20 is a tip 26. Importantly, the tip 26 should be made of a material having a very high thermal conductivity, such as copper or steel. It can be appreciated by those skilled in the art that the system 10 is typical of cryo-catheter systems. The system 10 applies the principles of thermodynamics and latent heat transfer to cool a thermally conductive tip 26 for cryoablation of tissue in the vasculature of a patient. The present invention contemplates a system 10 with a system controller 28 in electronic communication with both the pressure regulators 18a and 18b and a temperature sensor 30 (not shown in FIG. 1) mounted at the distal end of the cryo-catheter 20.

As shown in FIG. 2A and FIG. 2B, at the distal portion of the cryo-catheter 20, a capillary tube 32 is in fluid communication with a supply tube 34. At the distal end 36 of the capillary tube 32, a cryo-chamber 38 is formed when the tip 26 is connected to the distal end of the cryo-catheter 20. Specifically, the cryo-chamber 38 encapsulates the distal end 36 of the capillary tube 32. The structural consequence of the present invention is that the fluid refrigerant can transit the lumen 40 of the supply tube 34, flow through the lumen 42 of the capillary tube 32, and enter the cryo-chamber 38.

Mounted at the distal end of the cryo-catheter 20 is a temperature sensor 30. In the preferred embodiment of the present invention, as shown in FIG. 2A, the temperature sensor 30 is mounted on the tip 26. More particularly, the temperature sensor 30 is mounted on the interior surface 44 of the tip 26, and is oriented normal to the direction of flow defined by the capillary tube 32. A temperature sensor 30 may also be mounted on the exterior surface 46 of the tip 26 if operational considerations permit. In another embodiment of the present invention, as shown in FIG. 2B, the temperature sensor 30 may be mounted on the distal end 36 of the capillary tube 32. In both FIGS. 2A and 2B, the temperature sensor 30 is in electronic communication with the system controller 28 via an electronic wire 48, mounted coaxially with the cryo-catheter 20. Importantly, for the purposes of the present invention, the temperature measured by the temperature sensor 30 is considered to be the tip temperature “Tₜ”.

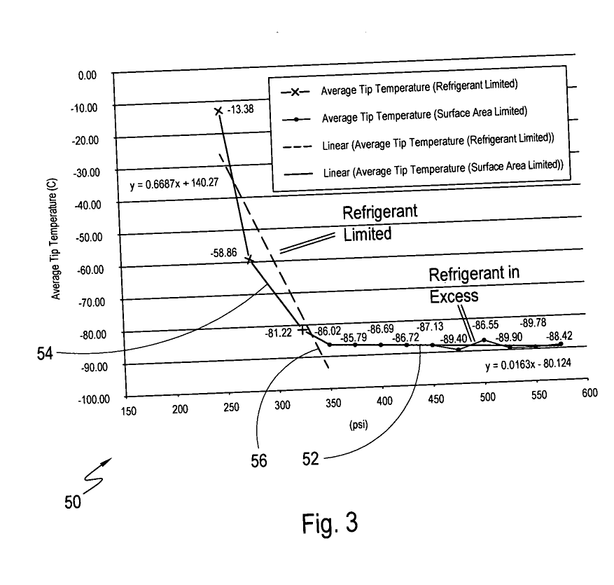

Referring now to FIG. 3, an exemplary pressure-temperature curve 50 is presented which plots tip temperature “Tₜ” (y-axis) as a function of working pressure “p_{w}” (x-axis), based on empirical data for a capillary tube 32 of a known lumen 42 length and diameter. As can be seen by referring to FIG. 3, there is a region 52 of the curve 50 where a change in working pressure “p_{w}” results in little or no measurable change in tip temperature “Tₜ”. In this region 52 of the curve 50, the fluid refrigerant is in a liquid state, i.e. “refrigerant in excess”. Alternatively, there is a region 54 of the curve 50 where a relatively small change in working pressure “p_{w}” results in a relatively significant change in tip temperature “Tₜ”. In this region 54 of the curve 50, the fluid refrigerant is in a gaseous state, and is referred to as “refrigerant limited”. Referring still to FIG. 3, it can be seen that there is a transition region 56 between the liquid and gaseous states of the fluid refrigerant, characterized by a pronounced change in slope of the pressure-temperature curve 50. With regard to the pressure-temperature curve 50, the slope may be defined as the change in temperature (ΔT) divided by the change in pressure (Δp). For example, in the “refrigerant limited” region 54 of the curve 50, a decrease in temperature corresponds to an increase in pressure, yielding a negative slope (i.e. (−)ΔT/(+)Δp). The slope of the curve 50 changes from a value approaching zero at higher pressures (“refrigerant in excess”), to a significantly negative slope at lower pressures, as the refrigerant begins to boil (“refrigerant limited”). As can be envisioned by referring to FIG. 3, in this transition region 56 there may also be a change in the sign of the slope of the curve 50 (e.g. from a (+) slope to a (−) slope as the pressure decreases). In the region 56 of the curve 50 where the fluid refrigerant transitions from a liquid to a gas, the tip temperature “Tₜ”, as measured by the temperature sensor 30, will be substantially at a minimum. This is the preferred operational state for the cryo-catheter 20. Of note, while FIG. 3 is specific to a particular capillary tube 32 of a specified lumen 42 length and diameter, it is exemplary of a curve 50 that can be plotted for any capillary tube 32 of known dimensions.

In operation, the present invention takes advantage of the thermodynamic phenomenon discussed above. The fluid refrigerant, after being cooled by the pre-cooler 16, is in a liquid state as it enters the supply tube 34. The fluid refrigerant enters the supply tube 34 at a working pressure “p_{w}” of approximately 350-500 psia. The supply tube 34 is dimensioned so as to cause a minimal drop in pressure as the fluid refrigerant transits the supply tube 34. As the fluid refrigerant passes into the capillary tube 32, it is still in a liquid state. It is desirable that the fluid refrigerant remains a liquid as it transits the capillary tube 32, until such time as it exits the distal end 36 of the capillary tube 32 and enters the cryo-chamber 38. The capillary tube 32 is dimensioned to effectuate this result.

As the fluid refrigerant transits the capillary tube 32 and enters the cryo-chamber 38, the pressure on the fluid refrigerant is reduced from approximately the working pressure “p_{w}” to a tip pressure “pₜ”. For the present invention, the tip pressure “pₜ” in the cryo-chamber 38 will preferably be less than approximately one atmosphere. The establishment and maintenance of the tip pressure “pₜ” is facilitated by the action of the vacuum source 22 that operates to evacuate the fluid refrigerant from the system 10 through the vacuum return line 24. As the fluid refrigerant exits the distal end 36 of the capillary tube 32 and enters the cryo-chamber 38, the decrease in pressure to less than approximately one atmosphere causes the liquid fluid refrigerant to start to boil. Referring again to FIG. 3, this change in state, from a liquid to a gas, occurs in the transition region 56 of the pressure-temperature curve 50, between the conditions of “refrigerant in excess” and “refrigerant limited”.

The present invention takes advantage of this empirically defined transition to control the working pressure “p_{w}” and the tip temperature “Tₜ”. In the preferred embodiment of the present invention, the temperature sensor 30, in electronic communication with the system controller 28, monitors the tip temperature “Tₜ” and electronically communicates that data to the system controller 28. The system controller 28, also in electronic communication with the pressure regulators 18a and 18b, monitors the working pressure “p_{w}” A control algorithm in the system controller 28 compares the working pressure “p_{w}” and the tip temperature “Tₜ” of the system 10 to the pressure-temperature curve 50 exemplified by FIG. 3. The control algorithm then calculates the working pressure “p_{w}” adjustment needed, if any, to achieve the desired minimal tip temperature “Tₜ”. Through a process which may be iterative, the working pressure “p_{w}” is automatically adjusted by the system controller 28. The system controller 28 will continue to adjust the working pressure “p_{w}” until such time as an increase in working pressure “p_{w}” results in little or no change in the tip temperature “Tₜ”, and a decrease in working pressure “p_{w}” results in a measurable increase in tip temperature “Tₜ”. Stated another way, if the fluid refrigerant begins to boil before exiting the distal end 36 of the capillary tube 32, the working pressure “p_{w}” is too low, and there is a corresponding significant increase in the tip temperature “Tₜ”. Under these conditions, an increase in working pressure “p_{w}” is warranted. However, at the point where a measurable increase in working pressure “p_{w}” produces little or no change in tip temperature “Tₜ”, the tip temperature “Tₜ” is minimized, and the system controller 28 will not needlessly increase the working pressure “p_{w}” any further.

In yet another embodiment of the present invention, the system controller 28 provides a visual representation of the tip temperature “Tₜ” data. Unlike the closed-loop system 10 described above, adjustments to the working pressure “p_{w}”, if necessary, can be effected by manually adjusting the pressure regulators 18a and 18b.

While the particular Pressure-Temperature Control for a Cryoablation Catheter System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A heat transfer system which comprises:
a supply tube having a proximal end and a distal end;
a capillary tube having a proximal end and a distal end, with said proximal end thereof connected in fluid communication with said distal end of said supply tube;
a tip member positioned to surround said distal end of said capillary tube forming a cryo-chamber therebetween;
a source of refrigerant fluid, connected in fluid communication with said proximal end of said supply tube;
a means for introducing the refrigerant fluid into said supply tube at a working pressure “p_{w}”, for transfer of the refrigerant fluid through said supply tube and through said capillary tube to exit from said distal end of said capillary tube and into said cryo-chamber in a substantially liquid state, for transition of the refrigerant fluid into a gaseous state with a tip pressure “pₜ” and a tip temperature “Tₜ”, for heat transfer through said tip member and into the gaseous fluid refrigerant in said cryo-chamber;
a temperature sensor for measuring the tip temperature “Tₜ”; and
a means connected to said temperature sensor and to said introducing means for controlling said working pressure “p_{w}” according to the tip temperature “Tₜ” to minimize the tip temperature “Tₜ.”

2. A system as recited in claim 1 wherein said refrigerant fluid is nitrous oxide (N₂O).

3. A system as recited in claim 1 wherein said working pressure “p_{w}” is in a range between three hundred and fifty psia and five hundred psia.

4. A system as recited in claim 1 wherein a pressure regulator is in fluid communication with said source of said fluid refrigerant and said controlling means.

5. A system as recited in claim 1 wherein said temperature sensor is mounted on an interior surface of said tip member.

6. A system as recited in claim 1 wherein said temperature sensor is mounted on said distal end of said capillary tube.

7. A system as recited in claim 1 wherein said tip pressure “pₜ” is less than one atmosphere.

8. A system as recited in claim 1 wherein the tip temperature, “Tₜ”, is less than minus eighty-four degrees Centigrade (Tₜ<−84° C.).

9. A system as recited in claim 1 wherein said controlling means is a system controller which comprises: a signal receiver, a processor, and a pressure control algorithm.

10. A heat transfer system which comprises:
a means for providing a liquid refrigerant at a first pressure;
a means for reducing the pressure on said liquid refrigerant from said first pressure to a second pressure;
a means for introducing said liquid refrigerant into a cryo-chamber at said second pressure for transition of said liquid refrigerant into a gaseous state in said cryo-chamber to cause heat to transfer from outside said cryo-chamber, into said cryo-chamber;
a means for sensing a temperature in said cryo-chamber; and
a means connected to said sensing means and to said introducing means for controlling said first pressure according to the temperature in said cryo-chamber to minimize the temperature in said cryo-chamber.

11. A system as recited in claim 10 wherein said liquid refrigerant is nitrous oxide (N₂O).

12. A system as recited in claim 10 wherein said reducing means comprises:
a supply tube having a proximal end and a distal end; and
a capillary tube having a proximal end and a distal end, with the proximal end thereof connected in fluid communication with the distal end of said supply tube.

13. A system as recited in claim 10 wherein said sensing means is a temperature sensor mounted in said cryo-chamber.

14. A system as recited in claim 12 wherein said sensing means is a temperature sensor mounted on said distal end of said capillary tube.

15. A system as recited in claim 10 wherein said means for controlling said first pressure comprises: a system controller, a processor, a pressure control algorithm, and a pressure regulator.

16. A method for transferring heat which comprises the steps of:
providing a liquid refrigerant at a first pressure;
reducing the pressure on said liquid refrigerant from said first pressure to a second pressure;
introducing said liquid refrigerant into a cryo-chamber at said second pressure for transition of said liquid refrigerant into a gaseous state in said cryo-chamber to cause a transfer of heat from outside said cryo-chamber, through a tip, and into said cryo-chamber;
sensing a tip temperature, “Tₜ”;
electronically communicating said tip temperature “Tₜ” to a system controller; and
controlling said first pressure according to said tip temperature “Tₜ” to minimize said tip temperature, “Tₜ”.

17. A method as recited in claim 16 wherein said liquid refrigerant is nitrous oxide (N₂O).

18. A method as recited in claim 16 wherein said first pressure is a working pressure “p_{w}” in a range between three hundred and fifty psia and five hundred psia, and said second pressure is a tip pressure “pₜ” of less than one atmosphere.

19. A method as recited in claim 16 wherein the tip temperature “Tₜ” is less than minus eighty-four degrees Centigrade (Tₜ<−84° C.).

20. A method as recited in claim 16 wherein said controlling the first pressure step comprises the steps of:
receiving a tip temperature “Tₜ” from a temperature sensor;
processing a control algorithm;
calculating an adjustment to said first pressure; and
controlling said first pressure.
